(19) United States
(12) Patent Application Publication
(10) Pub. No.: US 2025/0047084 A1
(43) Pub. Date: Feb. 6, 2025

(54) LOCK MECHANISM AND PROTECTOR

(71) Applicant: YAZAKI CORPORATION, Tokyo (JP)

(72) Inventors: Hiroaki Saito, Toyota-shi (JP); Yoshiro Tasaka, Toyota-shi (JP); Takashi Nomoto, Toyota-shi (JP); Ayumu Takagi, Toyota-shi (JP); Toru Kato, Toyota-shi (JP); Naoki Terada, Toyota-shi (JP)

(21) Appl. No.: 18/759,725

(22) Filed: Jun. 28, 2024

(30) Foreign Application Priority Data
Jul. 31, 2023 (JP) 2023-124058

(51) Int. Cl. H02G 3/06

(52) U.S. Cl. CPC H02G 3/0608

(57) ABSTRACT

A locking groove portion provided in a first protector includes a pair of guide rails extending along a locking insertion/removal direction and inclined upward from an opening portion to a wall portion in the locking insertion/removal direction and a locking protrusion portion provided in a second protector includes a pair of guided members guided by the pair of guide rails, respectively when inserted into the locking groove portion, each of the pair of guided members being inclined upward from a rear end portion to a front end portion of the locking protrusion portion.

### CROSS-REFERENCE TO RELATED APPLICATION(S)

The present application claims priority to and incorporates by reference the entire contents of Japanese Patent Application No. 2023-124058 filed in Japan on Jul. 31, 2023.

### BACKGROUND OF THE INVENTION

### 1. Field of the Invention

The present invention relates to a lock mechanism and a protector.

### 2. Description of the Related Art

Conventionally, as a technique related to a lock mechanism for assembling and fixing a first member and a second member to each other, for example, there has been disclosed a technique of assembling a first protector (first member) allowing a first wiring member to be inserted thereinto along an axial direction and a second protector (second member) stacked on the first protector in a stacking direction intersecting the axial direction and allowing a second wiring member to be inserted thereinto along the axial direction (see, for example, Japanese Patent Application Laid-open No. 2015-15813).

By the way, the technique described in Japanese Patent Application Laid-open No. 2015-15813 has room for further improvement, for example, in terms of the workability of assembling the first protector and the second protector to each other.

### SUMMARY OF THE INVENTION

The present invention has been made in view of the aforementioned circumstances, and an object of the present invention is to provide a lock mechanism and a protector capable of further improving workability in assembling a first member and a second member to each other.

To achieve the above objection, a lock mechanism according to one aspect of the present invention includes a locking groove portion provided in one of a first member and a second member stacked on each other to be recessed toward one side in a stacking direction in which the first member and the second member are stacked, with one side being opened and the other side being closed in a locking insertion/removal direction intersecting the stacking direction; and a locking protrusion portion provided in the other of the first member and the second member to protrude toward the one side in the stacking direction, and inserted into the locking groove portion from the one side in the locking insertion/removal direction through the opening to be locked to the locking groove portion, wherein the locking groove portion includes a pair of guide rails extending along the locking insertion/removal direction and inclined toward the one side in the stacking direction from the one side to the other side in the locking insertion/removal direction, and the locking protrusion portion includes a pair of guided members guided by the pair of guide rails, respectively, when inserted into the locking groove portion, each of the pair of guided members being inclined toward the one side in the stacking direction from the one side to the other side in the locking insertion/removal direction.

A protector according to another aspect of the present invention includes a first member allowing a first wiring member to be inserted thereinto along an axial direction; a second member stacked on the first member in a stacking direction intersecting with the axial direction and allowing a second wiring member to be inserted thereinto along the axial direction; and a lock mechanism connecting the first member and the second member to each other, wherein the lock mechanism includes a locking groove portion provided in one of the first member and the second member stacked on each other to be recessed toward one side in the stacking direction, with one side being opened and the other side being closed in a locking insertion/removal direction intersecting the stacking direction, and a locking protrusion portion provided in the other of the first member and the second member to protrude toward the one side in the stacking direction, and inserted into the locking groove portion from the one side in the locking insertion/removal direction through the opening to be locked to the locking groove portion, and the locking groove portion includes a pair of guide rails extending along the locking insertion/removal direction and inclined toward the one side in the stacking direction from the one side to the other side in the locking insertion/removal direction, and the locking protrusion portion includes a pair of guided members guided by the pair of guide rails, respectively, when inserted into the locking groove portion, each of the pair of guided members being inclined toward the one side in the stacking direction from the one side to the other side in the locking insertion/removal direction.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a wire harness to which a protector according to the present embodiment is applied;

FIG. 2 is a partially enlarged perspective view illustrating the vicinity of a locking groove portion that constitutes a part of a lock mechanism and is provided in a first protector;

FIG. 3 is a partially enlarged perspective view illustrating the vicinity of a locking protrusion portion that constitutes a part of the lock mechanism and is provided in a second protector;

FIG. 4 is a partially enlarged perspective view for explaining an operation of inserting the locking protrusion portion into the locking groove portion;

FIG. 5 is a partial cross-sectional view taken along a locking insertion/removal direction at a position of a guide rail of the locking groove portion in a state before the locking protrusion portion is inserted into the locking groove portion; and

FIG. 6 is a partial cross-sectional view taken along the locking insertion/removal direction at a position of a locking portion of the locking protrusion portion in a state after the locking protrusion portion is inserted into the locking groove portion.

### DETAILED DESCRIPTION OF THE PREFERRED EMBODIMENTS

Hereinafter, an embodiment according to the present invention will be described in detail with reference to the drawings. Note that the present invention is not limited by the present embodiment. In addition, the components in the present embodiment include those that can be easily replaced by those skilled in the art or those that are substantially the same. Note that, in the present specification, ordinal numbers are used only to distinguish components, members, parts, positions, directions, and the like, and do not indicate order or priority.

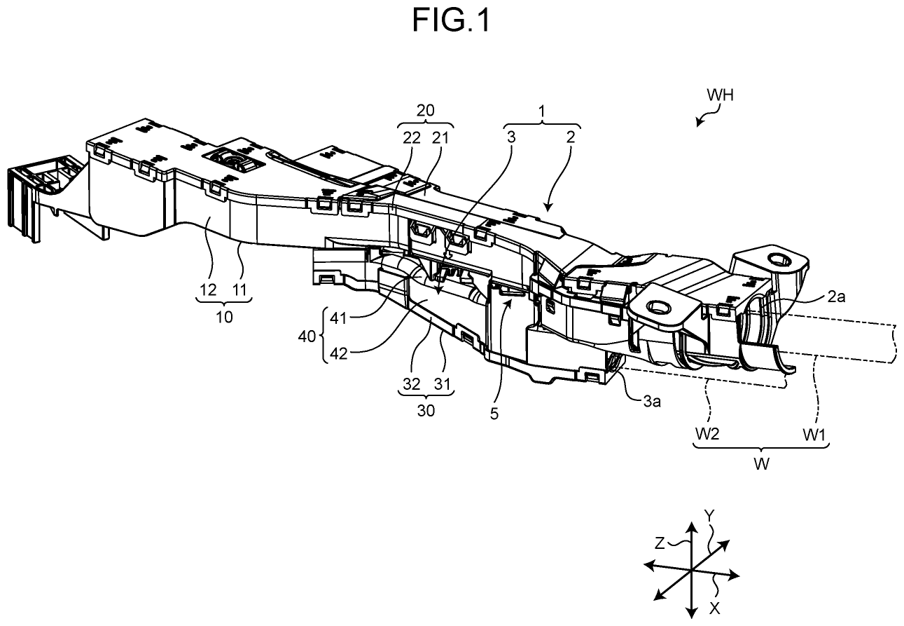

FIG. 1 is a perspective view of a wire harness to which a protector according to the present embodiment is applied. A protector 1 illustrated in FIG. 1 is incorporated in a wire harness WH wired in a vehicle or the like. Here, the wire harness WH is, for example, a collective component in which a plurality of wiring members W used for power supply and signal communication are bundled to connect devices mounted on the vehicle to each other, and the plurality of wiring members W are connected to the respective devices by connectors or the like. The wire harness WH according to the present embodiment includes a plurality of wiring members W having conductivity, and a protector 1 attached to the plurality of wiring members W to protect the wiring members W. The wire harness WH may further include various other components such as a corrugated tube, a grommet, an electrical connection box, a fixture, and a connector.

In the following description, among a first direction, a second direction, and a third direction intersecting each other, the first direction will be referred to as an “axial direction X”, the second direction will be referred to as a “locking insertion/removal direction Y”, and the third direction will be referred to as a “stacking direction Z”. Here, the axial direction X, the locking insertion/removal direction Y, and the stacking direction Z are substantially orthogonal to each other. The axial direction X typically corresponds to a direction in which the wiring member W is inserted into the protector 1, and a direction in which the protector 1 and the wiring member W inserted into the protector 1 extend. The stacking direction Z typically corresponds to a direction in which a first protector (first member) 2 and a second protector (second member) 3 to be described below of the protector 1 are stacked, and is substantially parallel to a vehicle height direction. The locking insertion/removal direction Y typically corresponds to a direction in which the first protector 2 and the second protector 3 of the protector 1 are inserted into and removed from each other, and is substantially parallel to a width direction of the first protector 2 and the second protector 3. In addition, each direction used in the following description will be described as a direction in a state where the wiring member W is assembled to the protector 1 unless otherwise specified.

The wiring member W is formed of, for example, a metal rod, an electric wire, an electric wire bundle, or the like. The metal rod is formed by covering an outer side of a rod-shaped member having conductivity with an insulating coating. The electric wire is formed by covering an outer side of a conductor (core wire) made of a plurality of conductive metal wires with an insulating coating. The electric wire bundle is a bundle of electric wires. The wiring member W according to the present embodiment includes a first wiring member W1 and a second wiring member W2. Here, the description will be given assuming that the first wiring member W1 and the second wiring member W2 are formed in a substantially circular cross-sectional shape and have substantially the same outer diameter and shape, but the first wiring member W1 and the second wiring member W2 are not limited thereto. The first wiring member W1 is, for example, a high-voltage electric wire or the like, and the second wiring member W2 is, for example, a low-voltage electric wire or the like.

The protector 1 includes a first protector 2, a second protector 3, and a lock mechanism 5 that connects and fixes the first protector 2 and the second protector 3 to each other.

The first protector 2 is formed in a substantially tubular shape as a whole, and is attached to the vehicle. The first protector 2 has an insertion space portion 2a extending along the axial direction X inside, protects the first wiring member W1 inserted into the insertion space portion 2a, and regulates a path along which the first wiring member W1 is wired.

The second protector 3 is formed in a substantially tubular shape smaller than the first protector 2 as a whole, and is attached to the first protector 2 via the lock mechanism 5. The second protector 3 has an insertion space portion 3a extending along the axial direction X inside, protects the second wiring member W2 inserted into the insertion space portion 3a, and regulates a path along which the second wiring member W2 is wired.

The first protector 2 includes, for example, a base 10 and an upper cover 20 formed of a resin material or the like, and is formed in a substantially rectangular tubular shape as a whole by assembling the base 10 and the upper cover 20 to each other. The base 10 has a bottom wall 11 and a pair of side walls 12, and has a substantially U-shaped cross section intersecting the axial direction X. The bottom wall 11 is formed in, for example, an arc shape along the first wiring member W1, and extends along the axial direction X. The pair of side walls 12 are formed to protrude from both ends of the bottom wall 11 in the locking insertion/removal direction Y toward one side (the upper side in FIG. 1) in the stacking direction Z, and extends along the axial direction X. In the base 10, the bottom wall 11 and the pair of side walls 12 are integrally formed, and a space portion surrounded by the bottom wall 11 and the pair of side walls 12 functions as the above-described insertion space portion 2a.

The upper cover 20 is assembled to the base 10, and covers (closes) the insertion space portion 2a in the base 10. The upper cover 20 has an upper wall 21 and a pair of side walls 22, and has a substantially U-shaped cross section intersecting the axial direction X. The upper wall 21 is formed in, for example, a flat plate shape, and extends along the axial direction X. The pair of side walls 22 are formed to protrude from both ends of the upper wall 21 in the locking insertion/removal direction Y toward the other side (the lower side in FIG. 1) in the stacking direction Z, and extends along the axial direction X. In the upper cover 20, the upper wall 21 and the pair of side walls 22 are integrally formed, and partitions the above-described insertion space portion 2a from the outside in cooperation with the above-described base 10.

The second protector 3 includes, for example, a lower case 30 and an upper case 40 formed of a resin material or the like, and is formed in a substantially rectangular tubular shape as a whole by assembling the lower case 30 and the upper case 40 to each other. The lower case 30 has a lower wall 31 and a pair of side walls 32, and has a substantially U-shaped cross section intersecting the axial direction X. The lower wall 31 is formed in, for example, a flat plate shape, and extends along the axial direction X. The pair of side walls 32 are formed to protrude from both ends of the lower wall 31 in the locking insertion/removal direction Y toward one side in the stacking direction Z, and extends along the axial direction X. In the lower case 30, the lower wall 31 and the pair of side walls 32 are integrally formed, and a space portion surrounded by the lower wall 31 and the pair of side walls 32 functions as the above-described insertion space portion 3a.

The upper case 40 is assembled to the lower case 30, and covers (closes) the insertion space portion 3a in the lower case 30. The upper case 40 has an upper wall 41 and a pair of side walls 42, and has a substantially U-shaped cross section intersecting the axial direction X. The upper wall 41 is formed in, for example, a flat plate shape, and extends along the axial direction X. The pair of side walls 42 are formed to protrude from both ends of the upper wall 41 in the locking insertion/removal direction Y toward the other side in the stacking direction Z, and extends along the axial direction X. The upper wall 41 and the pair of side walls 42 are integrally formed in the upper case 40, and the upper case 40 partitions the above-described insertion space portion 3a from the outside in cooperation with the above-described lower case 30.

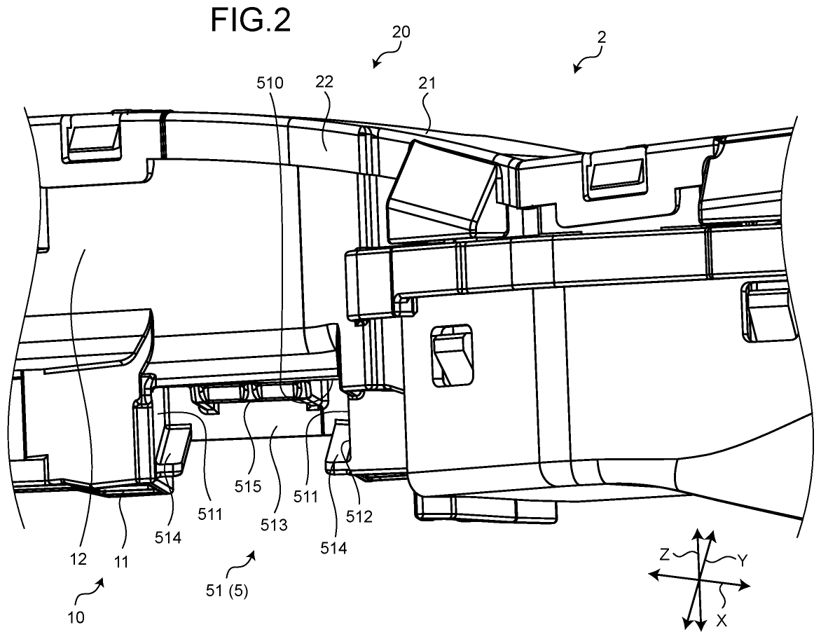

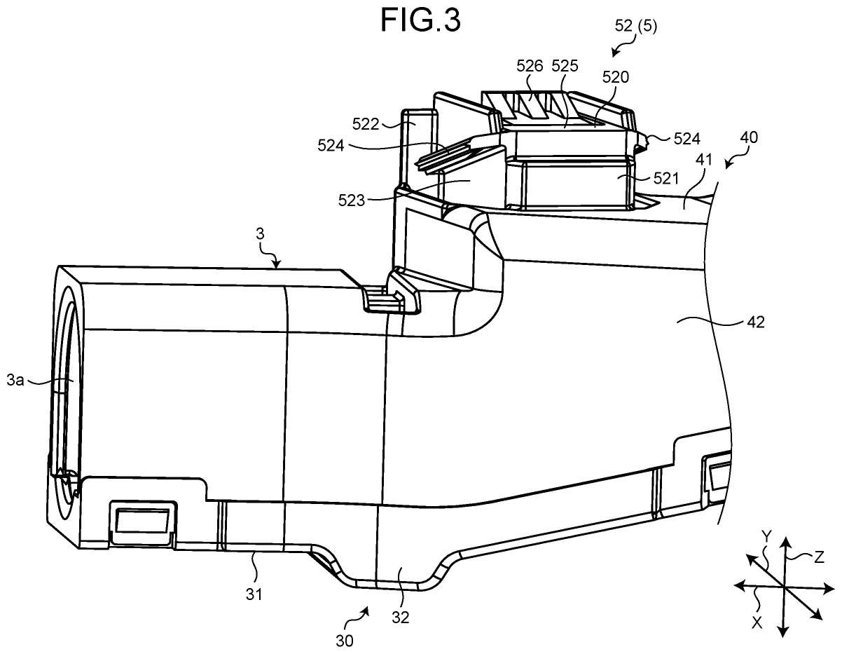

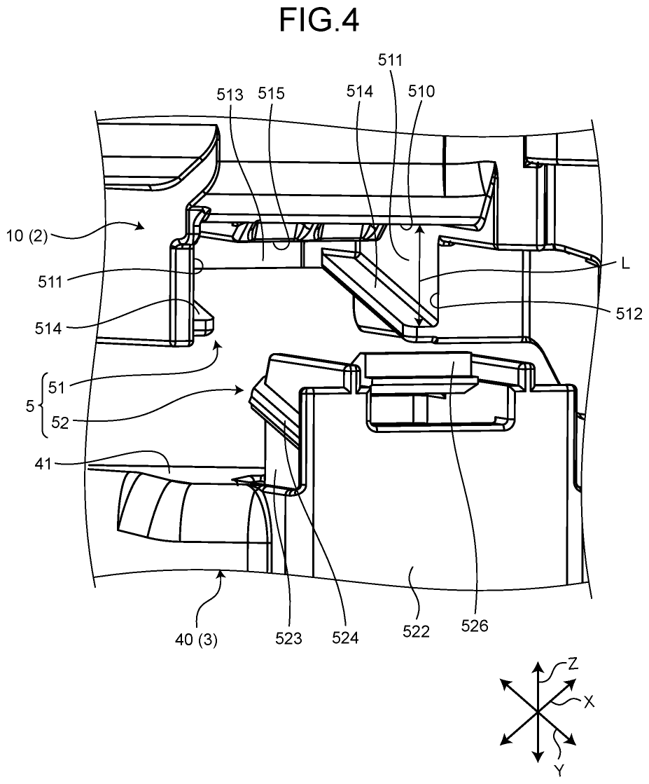

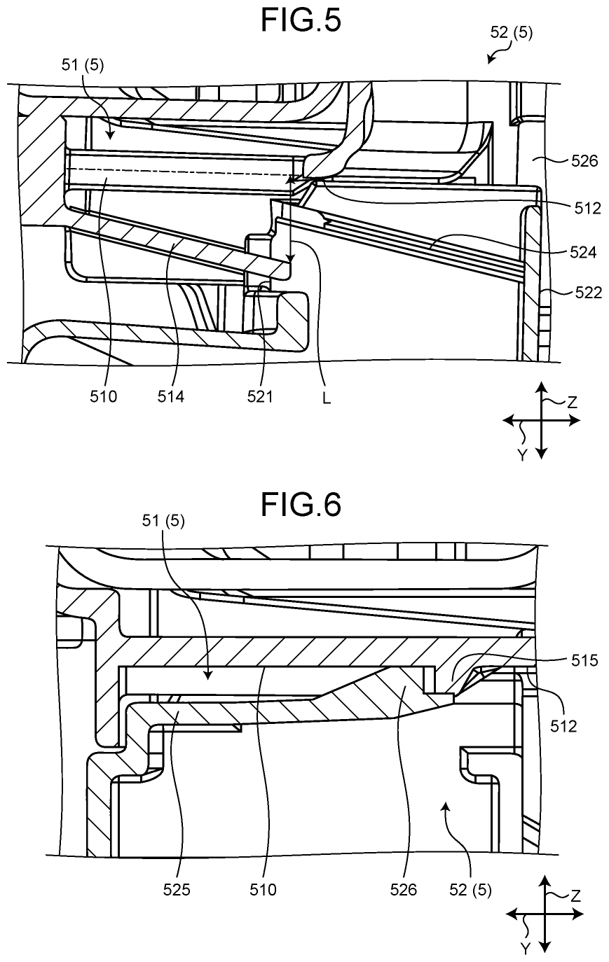

Next, the lock mechanism 5 will be described. FIG. 2 is a partially enlarged perspective view illustrating the vicinity of a locking groove portion that constitutes a part of the lock mechanism and is provided in the first protector. FIG. 3 is a partially enlarged perspective view illustrating the vicinity of a locking protrusion portion that constitutes a part of the lock mechanism and is provided in the second protector. FIG. 4 is a partially enlarged perspective view for explaining an operation of inserting the locking protrusion portion into the locking groove portion. FIG. 5 is a partial cross-sectional view taken along a locking insertion/removal direction at a position of a guide rail of the locking groove portion in a state before the locking protrusion portion is inserted into the locking groove portion. FIG. 6 is a partial cross-sectional view taken along the locking insertion/removal direction at a position of a locking portion of the locking protrusion portion in a state after the locking protrusion portion is inserted into the locking groove portion. The lock mechanism 5 is a portion that connects and fixes the first protector 2 and the second protector 3 to each other, and includes a locking groove portion 51 and a locking protrusion portion 52 as illustrated in FIGS. 2 and 3. In the present embodiment, the locking groove portion 51 is provided on the bottom wall 11 of the base 10 of the first protector 2, and the locking protrusion portion 52 is provided on the upper wall 41 of the upper case 40 of the second protector 3. Note that the lock mechanism 5 is not limited to the above-described configuration, and the locking groove portion 51 may be provided on the above-described upper wall 41, and the locking protrusion portion 52 may be provided on the above-described bottom wall 11.

The locking groove portion 51 is a portion into which the above-described locking protrusion portion 52 is inserted and fixed when the first protector 2 and the second protector 3 are assembled. As illustrated in FIG. 2, the locking groove portion 51 is formed by recessing the bottom wall 11 of the base 10 of the first protector 2 toward one side (the upper side in the example of FIG. 2) in the stacking direction Z. The locking groove portion 51 includes a top wall 510 spaced apart from the bottom wall 11 toward one side in the stacking direction Z, and a pair of side wall portions 511 located on both sides in the axial direction X and connecting the top wall 510 and the bottom wall 11. The top wall 510 and the side wall portions 511 extend along the locking insertion/removal direction Y, so that the locking groove portion 51 is formed as a groove portion extending along the locking insertion/removal direction Y. In addition, the locking groove portion 51 includes an opening portion 512 opened toward one side (the front side in the example of FIG. 2) in the locking insertion/removal direction Y, and includes a wall portion 513 closing the other side (the back side in the example of FIG. 2) in the locking insertion/removal direction Y. When the locking protrusion portion 52 is inserted into the locking groove portion 51, the wall portion 513 faces a front end portion 521 to be described below of the locking protrusion portion 52 in the locking insertion/removal direction Y.

In addition, the locking groove portion 51 includes a pair of guide rails 514 protruding to face each other in the axial direction X on the pair of side wall portions 511 described above. The guide rails 514 are members that support and guide guided members 524 to be described below of the locking protrusion portion 52 when the locking protrusion portion 52 is inserted into the locking groove portion 51. The guide rails 514 extend along the locking insertion/removal direction Y, and are provided to be inclined to one side in the stacking direction from one side to the other side in the locking insertion/removal direction Y. Specifically, the guide rails 514 are formed to be inclined upward from the opening portion 512 toward the wall portion 513 of the locking groove portion 51. In this configuration, as illustrated in FIGS. 4 and 5, a gap (guiding level) L between the guide rails 514 and the top wall 510 can be formed large in the opening portion 512 serving as an insertion port, making it easy to insert the locking protrusion portion 52 into the locking groove portion 51.

In addition, the locking groove portion 51 includes a projection portion 515 protruding to the other side in the stacking direction Z on one side in the locking insertion/removal direction Y of the top wall 510 described above. Specifically, as illustrated in FIGS. 4 and 6, the locking groove portion 51 includes a projection portion 515 protruding downward on a side of the top wall 510 close to the opening portion 512 described above. The projection portion 515 is a portion that is locked to a locking portion 526 to be described below of the locking protrusion portion 52 when the locking protrusion portion 52 is inserted into the locking groove portion 51. When the locking portion 526 of the locking protrusion portion 52 is locked to the projection portion 515 in the locking insertion/removal direction Y, the locking protrusion portion 52 is fixed in the locking groove portion 51.

On the other hand, the locking protrusion portion 52 is a portion that is inserted into and fixed to the locking groove portion 51 on the first protector 2 side. As illustrated in FIG. 3, the locking protrusion portion 52 includes a base portion 520 formed to protrude from the upper wall 41 of the upper case 40 of the second protector 3 toward one side (upward) in the stacking direction Z, and the base portion 520 is formed in a substantially square shape and extends along the locking insertion/removal direction Y. The locking protrusion portion 52 includes a front end portion 521 located on the other side in the locking insertion/removal direction Y of the base portion 520, a rear end portion 522 located on one side in the locking insertion/removal direction Y of the base portion 520, and a pair of side wall portions 523 located on both sides in the axial direction X of the base portion 520 and connecting the front end portion 521 and the rear end portion 522 to each other.

The front end portion 521 is a portion that is a front end when the locking protrusion portion 52 is inserted into the locking groove portion 51 along the locking insertion/removal direction Y, and faces the wall portion 513 of the locking groove portion 51. The pair of side wall portions 523 are portions facing the pair of side wall portions 511, respectively, when the locking protrusion portion 52 is inserted into the locking groove portion 51.

The locking protrusion portion 52 includes a pair of guided members 524 protruding to be spaced apart from each other in the axial direction X on the pair of side wall portions 523 described above. As illustrated in FIGS. 4 and 5, the guided members 524 are members that are guided by the guide rails 514 of the locking groove portion 51 when the locking protrusion portion 52 is inserted into the locking groove portion 51, and face the guide rails 514 on one side in the stacking direction Z. That is, the guided members 524 are positioned on the guide rails 514 and face the guide rails 514.

The guided members 524 extend along the locking insertion/removal direction Y, and are provided to be inclined to one side in the stacking direction from one side to the other side in the locking insertion/removal direction Y. Specifically, the guided members 524 are formed to be inclined upward from the rear end portion 522 toward the front end portion 521 of the locking protrusion portion 52. Inclination angles of the guided members 524 and the guide rails 514 are substantially the same, and the locking protrusion portion 52 can be easily attached and detached (inserted and removed) along the locking groove portion 51 by the guided members 524 sliding on the guide rails 514.

In addition, the locking protrusion portion 52 includes a locking portion 526 that abuts on the projection portion 515 provided on the top wall 510 of the locking groove portion 51 and is locked in the locking insertion/removal direction Y when the locking protrusion portion 52 is inserted into the locking groove portion 51. Specifically, as illustrated in FIGS. 3 and 6, the locking protrusion portion 52 includes an arm portion 525 provided to face the top wall 510 of the locking groove portion 51 when the locking protrusion portion 52 is inserted into the locking groove portion 51. The arm portion 525 is provided in such a manner as to have a fixed end on the front end portion 521 side (the other side in the locking insertion/removal direction Y) of the locking protrusion portion 52, and a free end on the rear end portion 522 side (one side in the locking insertion/removal direction Y). The locking portion 526 is provided on the free end side of the arm portion 525 to protrude toward one side (upward) in the stacking direction Z. When the locking protrusion portion 52 is inserted into the locking groove portion 51, the locking portion 526 abuts on the projection portion 515 provided on the top wall 510 of the locking groove portion 51, so that the arm portion 525 is bent toward the other side (downward) in the stacking direction Z, thereby pressing the guided members 524 against the guide rails 514. Then, when the locking protrusion portion 52 is further inserted, as illustrated in FIG. 6, the locking portion 526 climbs over the projection portion 515, and the locking portion 526 and the projection portion 515 are locked to each other in the locking insertion/removal direction Y, so that the locking protrusion portion 52 is fixed to the locking groove portion 51.

In the lock mechanism 5 configured as described above, the locking protrusion portion 52 is locked to the locking groove portion 51 from one side in the locking insertion/removal direction Y. At this time, as illustrated in FIGS. 4 and 5, the pair of guide rails 514 of the locking groove portion 51 is formed to be inclined upward from the opening portion 512 toward the wall portion 513 of the locking groove portion 51. Therefore, in the opening portion 512 serving as an insertion port, a gap L (guiding level) between the guide rails 514 and the top wall can be formed large, and the locking protrusion portion 52 can be easily inserted into the locking groove portion 51. Therefore, when the first protector 2 and the second protector 3 are connected to each other, it is possible to suppress a failure in inserting the locking protrusion portion 52 into the locking groove portion 51, preventing an incomplete connection (fitting failure). As a result, in the protector 1, the workability of assembling the first protector 2 and the second protector 3 can be further improved, and for example, the first protector 2 and the second protector 3 can be easily assembled even if a worker does not visually observe the lock mechanism 5.

As described above, in the lock mechanism 5 and the protector 1 according to the present embodiment, the locking groove portion 51 provided in the first protector 2 includes a pair of guide rails 514 extending along the locking insertion/removal direction Y and inclined upward from the opening portion 512 to the wall portion 513 in the locking insertion/removal direction Y, and the locking protrusion portion 52 provided in the second protector 3 includes a pair of guided members 524 guided by the pair of guide rails 514, respectively when inserted into the locking groove portion 51, each of the pair of guided members 524 being inclined upward from the rear end portion 522 to the front end portion 521 of the locking protrusion portion 52. Therefore, in the opening portion 512 serving as an insertion port, a gap L (guiding level) between the guide rails 514 and the top wall can be formed large, and the locking protrusion portion 52 can be easily inserted into the locking groove portion 51. Therefore, when the first protector 2 and the second protector 3 are assembled, it is possible to suppress a failure in inserting the locking protrusion portion 52 into the locking groove portion 51, preventing an incomplete connection (fitting failure). As a result, in the protector 1, the workability of assembling the first protector 2 and the second protector 3 can be further improved.

Although the embodiment of the present invention have been exemplified above, the above-described embodiment is merely an example, and is not intended to limit the scope of the invention. The above-described embodiment can be implemented in various other forms, and various omissions, substitutions, combinations, and changes can be made without departing from the gist of the invention. In addition, specifications such as configurations and shapes (structure, type, direction, form, size, length, width, thickness, height, number, arrangement, position, material, etc.) can be appropriately changed and implemented.

In the above-described embodiment, as the first member and the second member to which the lock mechanism 5 is applied, the first protector 2 and the second protector 3 that protect the wiring members W have been described by way of example, but the present invention is not limited thereto.

In the lock mechanism and the protector according to the present embodiment, a guiding level between the guide rails and the top wall can be formed large on one side of the locking groove portion serving as an insertion port, making it easy to insert the locking protrusion portion into the locking groove portion. Therefore, when the first member and the second member are assembled, it is possible to suppress a failure in inserting the locking protrusion portion into the locking groove portion, preventing an incomplete connection. As a result, the workability of assembling the first member and the second member to each other can be further improved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A lock mechanism comprising:
a locking groove portion provided in one of a first member and a second member stacked on each other to be recessed toward one side in a stacking direction in which the first member and the second member are stacked, with one side being opened and the other side being closed in a locking insertion/removal direction intersecting the stacking direction; and
a locking protrusion portion provided in the other of the first member and the second member to protrude toward the one side in the stacking direction, and inserted into the locking groove portion from the one side in the locking insertion/removal direction through the opening to be locked to the locking groove portion, wherein
the locking groove portion includes a pair of guide rails extending along the locking insertion/removal direction and inclined toward the one side in the stacking direction from the one side to the other side in the locking insertion/removal direction, and the locking protrusion portion includes a pair of guided members guided by the pair of guide rails, respectively, when inserted into the locking groove portion, each of the pair of guided members being inclined toward the one side in the stacking direction from the one side to the other side in the locking insertion/removal direction.

2. A protector comprising:
a first member allowing a first wiring member to be inserted thereinto along an axial direction;
a second member stacked on the first member in a stacking direction intersecting with the axial direction and allowing a second wiring member to be inserted thereinto along the axial direction; and
a lock mechanism connecting the first member and the second member to each other, wherein
the lock mechanism includes
a locking groove portion provided in one of the first member and the second member stacked on each other to be recessed toward one side in the stacking direction, with one side being opened and the other side being closed in a locking insertion/removal direction intersecting the stacking direction, and
a locking protrusion portion provided in the other of the first member and the second member to protrude toward the one side in the stacking direction, and inserted into the locking groove portion from the one side in the locking insertion/removal direction through the opening to be locked to the locking groove portion, and
the locking groove portion includes a pair of guide rails extending along the locking insertion/removal direction and inclined toward the one side in the stacking direction from the one side to the other side in the locking insertion/removal direction, and the locking protrusion portion includes a pair of guided members guided by the pair of guide rails, respectively, when inserted into the locking groove portion, each of the pair of guided members being inclined toward the one side in the stacking direction from the one side to the other side in the locking insertion/removal direction.
